(19) United States
(12) Patent Application Publication
(10) Pub. No.: US 2017/0286269 A1
(43) Pub. Date: Oct. 5, 2017

(54) Local Chat Service Simulator for Bot Development

(71) Applicant: Microsoft Technology Licensing, LLC, Redmond, WA (US)

(72) Inventors: Vitaliy Furman, Swindon (GB); Michael Stuart Lindre, Mawsley (GB); Gregory W . Wainer, London (GB); John Duncan Scott, South Croydon (GB); Paul M. Irwin, Harpenden (GB); Lucian Dragne, London (GB); Graham C. Plumb, London (GB); Michael M. Kaletsky, London (GB); Richard John Thorne, Northwood (GB); Adrian Kieron O'Grady, St. Neots (GB)

(73) Assignee: Microsoft Technology Licensing, LLC, Redmond, WA (US)

(21) Appl. No.: 15/271,017

(22) Filed: Sep. 20, 2016

(30) Foreign Application Priority Data
Mar. 30, 2016 (GB) 1605360.5

(51) Int. Cl. G06F 11/36

(52) U.S. Cl. CPC G06F 11/3664; G06F 11/3688

(57) ABSTRACT

A method of testing one or more bots, each bot being for interacting with one or more human users via a communication service implemented over a network where the bot is to be published to a server and the one or more users access the communication service using a communication client application. The method comprises: storing the one or more bots locally on a user terminal of a testing user being a human tester of the one or more bots, and running a bot testing application locally on said user terminal.

### PRIORITY

This application claims priority under 35 U.S.C. §119 or 365 to Great Britain Application No. 1605360.5 filed Mar. 30, 2016, the disclosure of which is hereby incorporated by reference herein in its entirety.

### BACKGROUND

Chat services can be used to offer a multitude of service to its users. One such service is the ability to communicate with an intelligent personal assistant. The intelligent personal assistant is offered to the user for communication and information purposes. Examples of such intelligent personal assistants are Microsoft's Cortana and Apple's Siri. The programming of the intelligent personal assistant can comprise one or more bots or chat-bots. Each of these bots can be programmed to perform specific tasks and respond to specific queries when requested with appropriate responses. For the developer of such a bot it is important to be able to test that the correct responses and information is returned by the bot. At the time of writing the code such interactive testing cannot be performed, and the developer must rely on line by line, or phrase by phrase coding checks, where the syntax or result of a direct command are checked. Should a developer wish to test their bot in its interactive capacity, they are required to publish their bot in an untested state to the necessary server. Once the bot is published to the server a developer can log into the relevant public chat client application and interact with their bot by exchanging communications and other queries to illicit the expected responses.

### SUMMARY

It has been recognised that when developing a bot for deployment for use in a communication service the bot requires testing before making it live within the service. Current methods for doing this require the bot to be uploaded or published to a server from where it can be accessed by a public chat client for testing. As a result, the developer must publish a bot without it being ready, these bots may not be final versions as there may be some corrections that need to be made. However, such corrections may only become apparent to the developer upon test interactions after publishing. This can then lead to a low-quality pool of bots published to the server. The process of uploading the bot to the server in order to interact with it is often slow, and third-party developers may find it undesirable to publish their bots to production before they are ready.

According to a first aspect of the present disclosure there is provided a method of testing one or more bots, each bot being for interacting with one or more human users via a communication service implemented over a network where the bot is to be published to a server and the one or more users access the communication service using a communication client application. The method comprises: storing the one or more bots locally on a user terminal of a testing user being a human tester of the one or more bots, and running a bot testing application locally on said user terminal. The bot testing application comprises: a detecting module configured to automatically detect one or more of the bots on said user terminal; and a user interface simulating module configured to render a simulated communications client user interface simulating at least one user interface function of said communication client application, including at least: presenting one or more of the detected bots as one or more respective ones of a plurality of simulated communication contacts within the simulated communications client user interface, with which the testing user can select to communicate. The bot testing application further comprises a backend simulating module configured to provide a simulated communications service backend simulating at least one backend function of said communication service, including at least: allowing the human tester to communicate with at least one of the one or more presented communication contacts, including at least one of said bots, so as to appear to be a published bot.

According to another aspect of the present invention there is provided a user terminal for carrying out any of the methods described herein.

According to another aspect of the present disclosure there is provided a computer program product comprising code embedded on computer-readable storage and configured so as when run on a user terminal performs any of the methods described herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

For a better understanding of the present invention and to show how the same may be put into effect, reference will now be made, by way of example, to the following drawings in which:

FIG. 1 shows a schematic illustration of a communication network comprising multiple services each with a respective user network of multiple users and user terminals;

FIG. 2 shows a schematic block diagram of a user terminal;

FIG. 3 shows a flow chart for a process of detecting a bot and simulating a user interface and client backend in order to test the detected bot;

FIG. 4 shows an example simulated client user interface.

### DETAILED DESCRIPTION

In the following description, numerous specific details are set forth to provide a more thorough understanding of the described embodiments. However, it will be apparent to one of skill in the art that the described embodiments may be practiced without one or more of these specific details. In other instances, well-known features have not been described in order to avoid obscuring the described embodiments.

Reference throughout this disclosure to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In many cases a software developer will not consider their bot to be the final version and ready for publication until it has been tested in the interactive chat, messaging and query scenario in which it will ultimately function. Traditional technologies require that these elements of the bot be tested by uploading the untested bot to a server through which it can be accessed via a public version of the relevant chat client. However, this requires most if not all of the technical steps that would be used when publishing the final version of the bot. So that the untested bot is not made public, the developer must then implement measures by which to hide the unfinished bot from members of the public who are using the public chat client. These technical steps are time consuming to implement, often require further access and authorization credentials, and result in a pool of low-quality and unfinished standard bots stored on the server. The embodiments described herein provide a method for locally testing bots, stored on a local machine. The developer of a bot can test their bot by hosting a simulated communication client user interface and simulated client backend on their local machine. As such a developer is not required to upload their bot to the server before testing the interactive and communication elements of the bot's programming, and is not required to release control of the bot before it is considered ready or of a final standard or in its final version. The developer can also be considered the testing user, the testing user being a human tester of the bot.

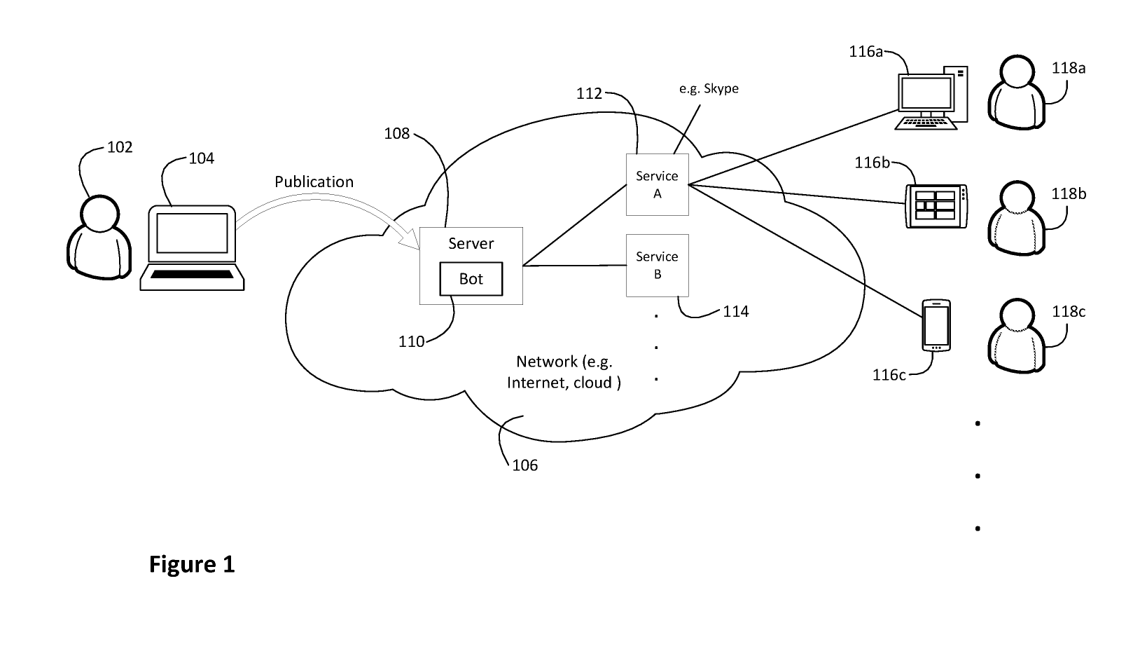

FIG. 1 shows a communication system comprising a user 102 (e.g. the developer, tester, or any other near end user of the system), a user terminal 104 (e.g. a laptop device etc.), a network 106 (e.g. the Internet, the cloud, or any other network through which communication messages and digital data may be sent), a server 108, a bot 110, service A 112, service B 114, multiple further user terminals 116 of various types (including 116a a PC device, 116b a tablet device, 116c a smartphone device, etc.), and multiple further users of the further user terminals 118a, 118b, and 118c, etc.

Near end user, user A, the developer or bot tester, is the user of user terminal 104. User terminal 104 is connected to network 106. User terminal 104 is connected to network 106. The connection is such that it enables uploading and/or publishing of chat-bots or bots to the server 108 and two-way communication therewith via available public chat client applications. Server 108 is a server of the network 106 and may be distributed throughout the network, in one or more physical locations, and as software, hardware, or any combination thereof. Server 108 also stores the bot 110 after the bot has been published or uploaded. The server 108 is connected to a number of services including service A 112 and service B 114. These services may be client services such as those of Skype, Telegram, WhatsApp, Slack, WeChat, etc. These services provide certain functionalities including communications services. These communication services may include instant messaging, video calls, voice calls, photo messaging, emojis, and emoticons, as well as any other communication type supported by the respective service, provider, and client application. Each of service A 112 and service B 114 have their own network of users. These networks may have some user or associated profile overlap or be completely distinct from each other. Service A 122 has a network of users including users 118a, 118b, and 118c, and may include any number of further users. The network of users 118 connect to the service A 112 through respective user terminals 116. Any one user within the network of users 118 may connect to the service A 112 via multiple different user terminals 116.

FIG. 1 outlines the traditional technique of testing a bot's responses when implemented in a communication environment. The bot 110 is uploaded from the developer's computer, user terminal 104, and stored on a server 108 of the network 106. The bot 110 may be sandboxed on the server 108. When sandboxed or in a sandbox the bot is isolated from other data on the live parts of the server 110. As such the live parts of the server are protected from changes made to the bot, and the bot itself, which could be damaging otherwise.

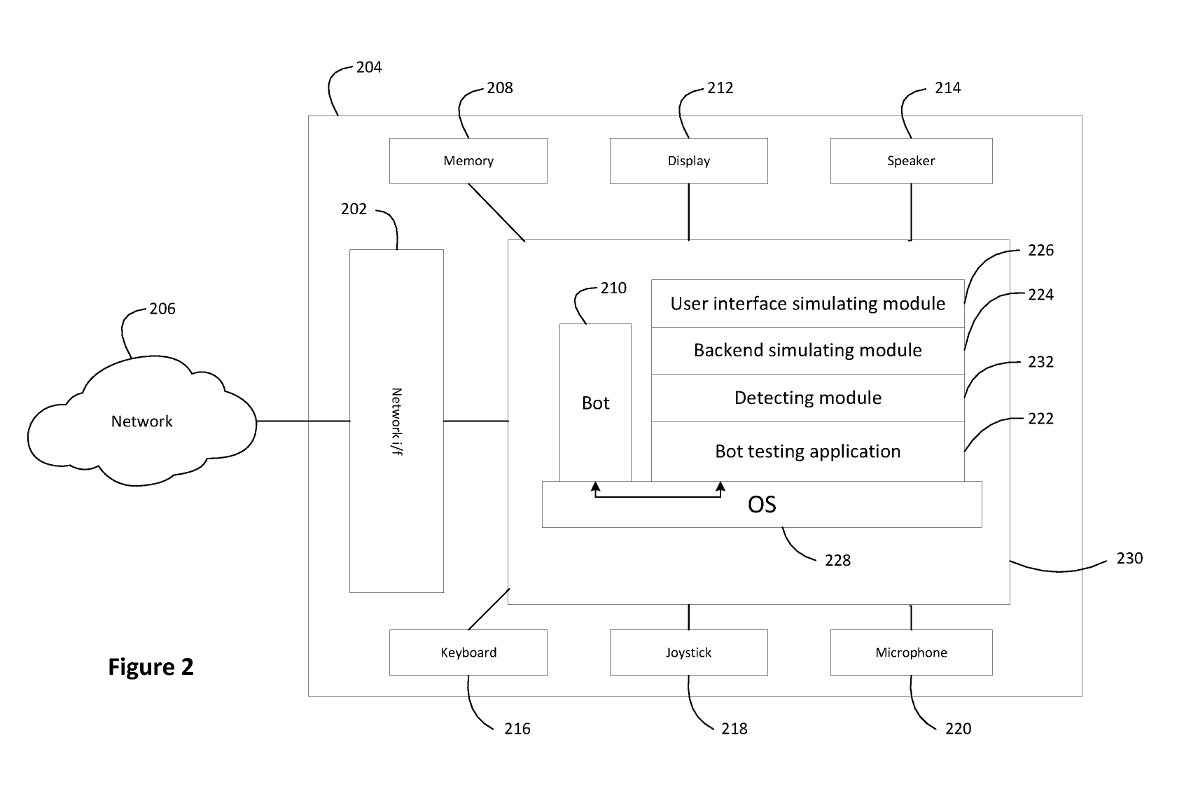

FIG. 2 shows a schematic of a user terminal 204. User terminal 204 comprises a central processing unit, CPU or processing module 230, the CPU runs the processes required to operate the user terminal and includes the operating system, OS 228. The OS may be of any type, for example Windows™, Mac OS™ or Linux™. The CPU is connected to a variety of input and output components including a display 212, a speaker 214, a keyboard 216, a joystick 218, and a microphone 220. A memory component 208 for storing data is connected to the CPU. A network interface 202 is also connected to the CPU, such as a modem for communication with the network 206. If the connection of the user terminal 204 to the network 206 via the network interface 202 is a wireless connection, then the network interface 202 may include an antenna for wirelessly transmitting signals to the network 206 and wirelessly receiving signals from the network 206. Any other input/output device capable of providing data or extracting data from terminal 204 may also be connected to the CPU. The above mentioned input/output components may be incorporated into the user terminal 204 to form part of the terminal itself, or may be external to the user terminal 204 and connected to the CPU 230 via respective interfaces.

The OS 228 is executed on the CPU 230, where it manages the hardware resources of the computer, and handles data being transmitted to and from the network 206 via the network interface 202. Running on top of the OS 228 is the software of the bot testing application 222. The bot testing application 222 has a detecting module 232, a backend simulating module 224 and a user interface simulating module 226. Also running on top of the OS 228 is the bot 210. The bot may have been retrieved from the memory 208, and caused to run on the OS 228. More than one bot 210 may run on the OS 228 at any one time. The bot testing application 222 communicates with the operating system 228 and manages the connections between the bot 210, the backend simulating module 224 and the user interface simulating module 226, as well as any connections over the network 206 via the network interface 202. The user interface simulating module 226 is used to simulate a client user interface and present information to the user 102. The backend simulating module 224 is used to simulate the backend of the simulated client, simulate the user network, and simulate the functions supported by the simulated client. In this way, the bot testing application 222 performs the processing required to simulate to the user 102 the service provided by the simulated client and enables the user 102 to use the functions of the simulated client backend via the simulated client user interface, in order to test the functionality of the bot 210.

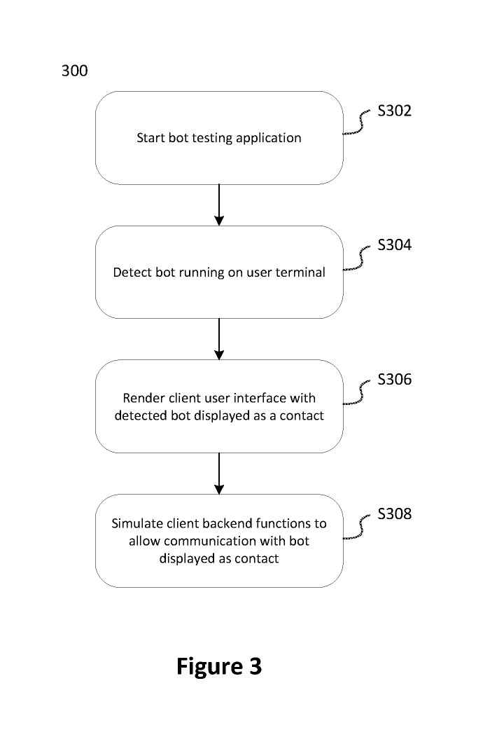

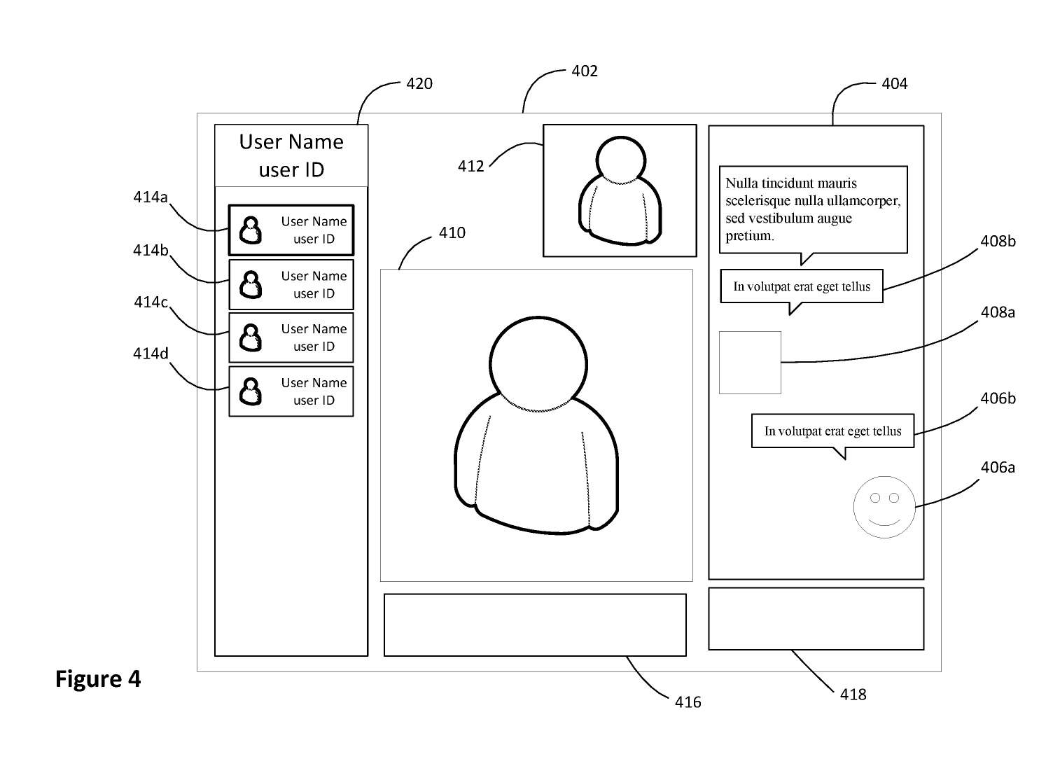

With reference to FIGS. 3 and 4 there is now described a method for simulating the client user interface and client backend of a service provided by a specific client. This simulation is hosted on a local terminal and enables a developer to test the functionality and interactions of a bot also located locally on the terminal.

FIG. 3 is a flow chart for a process 300 of detecting a bot and simulating a user interface and client backend in order to test the detected bot.

The process 300 starts at step S302 whereby the bot testing application 222 is caused to run on local terminal 104. On starting the bot testing application 222, the process proceeds to step S304 where detecting module 232 searches the local terminal 104 for any bot 210 stored locally on the terminal 104. Any bot found by detecting module 232 is subsequently available to be loaded as a contact in the simulated communications client user interface.

In an embodiment this may be done using C#'s reflection features to dynamically read any .dll and .exe files found stored on terminal 104. Other applicable file types may also be dynamically loaded depending on the coding, protocol used and the settings thereto provided. The search may be confined to specific libraries and directories stipulated by the user 102. Such libraries and directories may be stipulated by the user 102 either when prompted or by pre-defined settings. The search may comprise searching specific portions of memory 208 thus associated and accordingly specified as said libraries and directories.

In an embodiment the bot testing application 222 launches a web browser within which the simulated client user interface is rendered. Static html and Javascript files are subsequently served, allowing the user 102 to navigate to a URL on their web browser and see a web page. The Javascript could be generated from the superset Typescript, maintained by Microsoft, or any other superset or programming language that compiles to Javascript such as Haxe, CoffeeScript, Babel, Elm, etc. This can then be served by OWIN's (Open Web Interface for .NET) static file serving features. On the opening of the web page the Javascript code will open up a connection to the server. This connection between the client and server can be established using SignalR, Microsoft's real-time client-server communication library, or any other suitable server-side software system designed for writing scalable Internet applications. This server may be a simulated entity (at least in terms of prepared/being-tested code), that then becomes real upon actual deployment of the bot; or it may be an actual server. The server the simulator runs on may also be a partially simulated entity, whereby the server may be a modified version of the code that is then deployed to a cloud server. In this case it works in exactly the same way as it would do having been deployed to an actual server, except that when running locally the simulated user interface is visible.

On opening the web page, the process proceeds to step S306 where user interface simulating module 226 renders a simulated communications client user interface. An example of the simulated communications client user interface is shown in FIG. 4. One or more bots 210 detected by the detecting module 232 when the service started are displayed within the simulated user interface 402 as one or more contacts 414. On rendering the simulated user interface a unique user identification number or user ID 420 is generated and associated with that user interface. The user ID 420 is unique within the simulated client backend and its user network. This forgoes the requirement in traditional technologies where new real user accounts are required, and where the user ID is unique within the real and live service backend. That is to say traditional technologies would require creating a new user account for Skype. The new Skype user account being associated with a new real unique Skype user ID.

The simulated user interface simulates available function buttons and elements provided by the real public chat client user interface. For example, functioning buttons 416 for selection provide video and voice calling functionalities. User interface areas 410 and 412 provide the video and/or static image display areas for incoming and outgoing communication links respectively. A chat window area 404 is provided for displaying incoming and outgoing photo and/or text messages 406b 408b, emoticons or emojis 406a, mojis or stickers 408a, and any other associated or similar message types. A window area 418 is provided to allow the developer to enter and edit text or other types of messages as listed above, which will then be shown in area 404 once sent to the bot as a message.

In step S308 the process proceeds by simulating the functions of the communication service being simulated. That is to say the backend of the service is simulated, which enables the user 102, the bot developer, to send messages from their simulated client user interface to the bot, as well as receive the bot's responses. The bot being tested is selected from the one or more displayed contacts 414a-d, having been detected upon starting the bot testing application. The bot can thus be tested by the developer in order to ascertain whether it will provide the correct and/or appropriate responses to inputs from the developer.

Depending upon the programming of the bot 210 being communicated with, any type of communication can be exchanged, and thus the user 102 or developer can enter into an interactive test communication with the chosen bot 210. Sending a message to a bot will cause the bot's code to run, and it will react accordingly. Developer to bot communications are handled by OWIN route-mapping so as to be consistent with real-life bot services for communication programs, for example Skype etc. The bot is able to send any of the above described communication types. If the bot sends a return communication to the user 102, the response will appear in the simulated communication client user interface within the user's 102 web browser.

The bot may also be tested for its response to certain situations. For example, the bot can be tested to see if it provides the desired and programmed responses to latency, dormant periods of communication, session timeouts, failed communications, and non-delivery of messages. This may be to replicate a user on a mobile device entering a signal blackspot, and thus observe the bot's responses to such a situation. Similarly, the bot's response to ticket expiry and connectivity issues can be tested. All of these scenarios can be simulated within the bot testing application, and such situations can therefore be tested at the will of the developer. Communications sent by a bot to the developer would be handled by SignalR, or any other suitable server-side software system designed for writing scalable Internet applications.

In traditional technologies where the developer is forced to upload their untested bot to the server 108 and test the sandboxed bot via a ‘real’ account and a public chat client, they are also forced to instigate any situation in which they wish to test the bot in reality. That is to say the developer would be required to create a real life situation where the communication fails, wait the predefined amount of time signifying a dormant conversation, or wait the number of hours for the communication session to timeout, in order to test the bot in these situations. As a result, testing the bot in just one situation could take a significant number of hours, e.g. 15 hours. As a result of having to use this method of testing the testing of the bot would take many hours more than in the presently present testing method.

In an embodiment the simulated user interface may be rendered in a way other than in a web browser. For example, the simulated user interface may be rendered using winforms, TK, Java swing, etc. The user interface may be rendered in an applet or a dedicated piece of software installed on local terminal 104.

The testing process is hosted on the local terminal 104 of the user 102. Further human users can be added to the simulated client backend network of users and are human-controlled contacts. Each human-controlled contact having an instance of the simulated communications client user interface and being able to communicate with any of the one or more bots having been detected and being tested. New human users may subsequently be added to an ongoing communication, a group conversation, or start a new conversation with any of the detected bots or other human users displayed as contacts. The new further human users are incorporated via further instances of the simulated client user interface. That is to say the same human may in reality control the communications input from the further human users of the simulated backend, but each further instance of the simulated client user interface is controlled by a human user and is a human-controlled contact. The simulated client user interfaces may all be presented on the same local machine 104, or they may each be opened on a different terminal of a local network 206. Any combination of simulated communication client user interfaces to user terminals is possible. The user 102 may be the only real human associated with such further simulated client user interfaces, and would therefore be communicating with themselves in subsequent cases of user-to-user communication. Such a situation would allow a developer, user 102, to test the bot's responses in group communication sessions and multiparty environments without requiring a second real human, or a second user terminal. Communications between users associated with different instances of the simulated client user interface would be handled by SignalR, or any other server-side software system designed for writing scalable Internet applications, e.g. Node.js etc.

A further simulated client user interface is created by opening a further web browser window, or further window/tab or similar aspect of the software being used to render the simulated client user interface. On opening another browser window another simulated client user interface is rendered and a new user is created within the simulated client backend. A new user ID is automatically generated for the new user. The new user ID is unique within the simulated client backend. The new user is able to communicate with any bots detected by the detection module, as well as with any of the other human users associated with any further instances of the simulated client user interface.

The above described feature enables the developer to create new human users with simulated client user interfaces, user contacts and include them in the simulated backend user network without having to create real dummy accounts that would then get stored in real-life. This also means that the developer doesn't have to worry about creating user IDs which are unique in the real and live client backend, and also allows the developer to create the new users and contacts as and when needed. The new human users can be temporary and removed or closed as easily as they are created.

Each new human user created may have an operating mode and subsequently associated types of communication. That is to say each user may have a mode of operation associated with it which defines the types of communication it is able to send and/or receive when communicating with a bot or other human user. This may be set when each individual new human user is created, or it may be a default setting dependent on the operating mode of the bot testing application.

In an embodiment the bot testing application has a number of operating modes. Each operating mode is associated with one provider or client of a number of available providers or clients. Thus the selection of one mode specifies the specific provider the developer wishes to simulate and results in the user interface and backend of this specific provider being simulated by the bot testing application. That is to say that the bot testing application is platform agnostic. The bot testing application can simulate a number of different platforms such as Skype, Telegram, WhatsApp, etc and the developer can choose which platform they wish to test their bot in. This could involve a platform adapter in order to simulate specific provider and/or services. Thus a polymorphic development environment is provided.

In an embodiment the bot being tested using the bot testing application can respond to queries using non-conversational state information. Non-conversational state information is information associated with a particular user (with a unique user ID), but not communicated directly to the bot. For example, a user may have a location, a presence, a local time of day or date. A user may ask the bot for names and contact information for local Chinese restaurants. The location of the user is the non-conversational state information and is known by the bot. The bot can then use this state information to ascertain the Chinese restaurants close to the user's location. Or the user may query the bot about tomorrow's weather. Again in this instance the non-conversational state information would be the location of the user.

Using traditional techniques, if a developer wanted to test the correctness or appropriateness of the response given by a bot to this type of query, having uploaded the bot to be tested to the server 108, the developer would then have to travel to the actual location in order for the state information to reflect this.

The bot testing application presently discussed allows the state information to be set by the developer. The developer can set the location of any user to any desired location. Different users simulated by the bot testing application can be given different locations and therefore given different state information relative to each other. Other types of state information can also be similarly set and include presence, date, time of day, day of the week, successful or unsuccessful payment being made, etc. Where presence is a condition related to the activity of the user, for example away, busy, active/available etc. This information can be displayed either next to the relevant user when seen as a contact in a contact list, or in the home screen of the user the information is associated with. The non-conversational information can be included the user's profile information. The non-conversational state information can thus be known by the bot without being imparted in a communication.

Testing how the bot responds to this information, as well as to queries around this information is a functionality supported by the bot testing application. For example, the bot may respond to particular dates, e.g. national holidays or personalized calendar entries, by sending specific stickers, text messages, and other types of communication. The dates may include for example the user's birthday, the birthday of a contact, New Year, Christmas, user entered holiday dates, Valentine's day etc. The bot may respond to times of day with appropriate responses centered around likely situations for that time of day, for example ‘good morning’, ‘goodnight’, and meal times, etc. The developer can thus test bot responses by changing the time of day for the respective user, and check that the bot gives the desired response. A developer using the traditional technologies would have to wait for a specific time of day in reality in order for said time to be presented as the state information of the public chat client being used.

Other state information can be set by the developer as required in order to test any programmed response of the bot being tested. This enables the developer to test responses of the bot more quickly, within hours rather than days. Tests can be performed without delay caused by having to wait for certain state information to match the criteria needed to trigger responses from the bot that the developer wishes to test.

Traditional technologies which require uploading the bot to the server 108 often require access and permission credentials in order to allow the developer to upload their bot to the server 108. Such access can be difficult and time consuming to obtain. It can also be difficult to share access credentials, so in collaborative development environments uploading bots for testing may rest with a specific developer within the group. This can cause problems when the specific developer with access credentials may not be the developer with the test version of the bot to be uploaded. In an embodiment of the presently discussed bot testing application such difficulties are circumvented as the bot testing application enables the communication backend to be hosted on a local terminal. The local terminal hosting the simulated backend can be part of a local network. Any number of developers in a collaborative group can join the local network using their own terminals. Thus the additional developers can open simulated client user interfaces on their terminals, allowing them to also test a bot using the simulated client backend hosted on the local terminal (running the first instance of bot testing application). Any combination of bots and at least one user may exist within the simulated communication client user interface and simulated client backend. The bot testing application can use these hosting capabilities to focus test a bot.

It should be appreciated that the simulated communications client user interface has no requirement to replicate the live public chat client user interface in appearance. All that is required are the user interface elements to enable the developer to test the functionality of the bot within the chosen client platform. Therefore, it should be appreciated that FIG. 3 only gives an example of the appearance of the simulated communications client user interface and how the simulated backend functions might be enabled by the communications client user interface elements. Sufficient interface areas to display the various types of communication that may be received from the bot being tested, and for inputting communications from the developer to test the bot's reactions are all that is required. That is to say there is provided a sense of being in the front-end of a client application and thus of the user experience of the end user, but this need not look similar to the live public chat client user interface.

In an embodiment new users are added by opening new windows in the web browser without requiring the restarting of the bot testing application. New bots can be made available and detected while the bot testing application is running. These will appear as new contacts, and communication would then be enabled with them as with any other contact in the simulated user interface. These may be present on the local terminal running the bot testing application and hosting the simulated client backend, or on a further terminal of the local network i.e. belonging to another developer.

The method may further comprise in addition to the detected bots, one or more of said plurality of simulated communication contacts comprise one or more further, human-controlled contacts each having an instance of said simulated communications client user interface, wherein the further human-controlled contacts are controlled by said testing user and/or one or more further human users.

The method may further comprise the bot testing application being platform agnostic in that it is operable to simulate a communications client user interface and backend of a plurality of providers, and wherein the bot testing application is configured to enable the testing user to select an operating mode selecting the simulated communications client user interface and the simulated communications service backend from amongst those of said plurality of providers.

The method may further comprise simulating at least one backend function includes sending and/or receiving one or more types of communication, the types of communication sent and/or received being dependent upon the selected operating mode.

The method may further comprise for each of the human-controlled contacts, a respective further instance of the simulated communications client user interface rendered in a separate window and a new respective unique user ID being generated to identify the human-controlled contact.

The method may further comprise the simulated communications client user interface being rendered in a web browser window.

The method may further comprise upon opening of a further web browser window a further one of said instances of the communications client user interface being rendered generating a new one of said human-controlled contacts and the respective unique user ID.

The method may further comprise the communication client user interface being rendered in a way other than in a web browser.

The method may further comprise the operating mode of the new user being defined when the new user is generated.

The method may further comprise the user associated with the simulated communications client user interface also being associated with non-conversational state information; said non-conversational state information being user defined.

The method may further comprise the bot being able to give a response to a query relative to said user's non-conversational state information; said communication comprises supplying the non-conversational state information to said at least one bot, thereby causing the bot to respond to the non-conversational state information.

The non-conversational state information is location; said location being user defined.

The non-conversational state information is presence; said presence being user defined.

The non-conversational state information is time and/or date; said time and/or date being user defined.

The method may further comprise the type of communication sent and/or received being any one or more of instant messages, voice calls, video calls, emoticons, picture messages, and/or video messages.

Generally, any of the functions described herein (e.g. the functional modules shown in FIG. 2 and the functional steps shown in FIG. 3) can be implemented using software, firmware, hardware (e.g., fixed logic circuitry), or a combination of these implementations. The modules and steps shown separately in FIGS. 2 and 3 may or may not be implemented as separate modules or steps. The terms “module,” “functionality,” and “component” as used herein generally represent software, firmware, hardware, or a combination thereof. In the case of a software implementation, the module, or functionality represents program code that performs specified tasks when executed on a processor (e.g. CPU or CPUs). The program code can be stored in one or more computer readable memory devices. The features of the techniques described herein are platform-independent, meaning that the techniques may be implemented on a variety of commercial computing platforms having a variety of processors. For example, the user devices may also include an entity (e.g. software) that causes hardware of the user devices to perform operations, e.g., processors functional blocks, and so on. For example, the user devices may include a computer-readable medium that may be configured to maintain instructions that cause the user devices, and more particularly the operating system and associated hardware of the user devices to perform operations. Thus, the instructions function to configure the operating system and associated hardware to perform the operations and in this way result in transformation of the operating system and associated hardware to perform functions. The instructions may be provided by the computer-readable medium to the user devices through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of testing one or more bots, each bot being for interacting with one or more human users via a communication service implemented over a network where the bot is to be published to a server and the one or more users access the communication service using a communication client application; where the method comprises:
storing the one or more bots locally on a user terminal of a testing user being a human tester of the one or more bots;
running a bot testing application locally on said user terminal, wherein the bot testing application comprises:
a detecting module configured to automatically detect one or more of the bots on said user terminal;
a user interface simulating module configured to render a simulated communications client user interface simulating at least one user interface function of said communication client application, including at least: presenting one or more of the detected bots as one or more respective ones of a plurality of simulated communication contacts within the simulated communications client user interface, with which the testing user can select to communicate; and
a backend simulating module configured to provide a simulated communications service backend simulating at least one backend function of said communication service, including at least: allowing the human tester to communicate with at least one of the one or more presented communication contacts, including at least one of said bots, so as to appear to be a published bot.

2. The method of claim 1, where in addition to the detected bots, one or more of said plurality of simulated communication contacts comprise one or more further, human-controlled contacts each having an instance of said simulated communications client user interface, wherein the further human-controlled contacts are controlled by said testing user and/or one or more further human users.

3. The method of claim 1 or 2, where the bot testing application is platform agnostic in that it is operable to simulate a communications client user interface and backend of a plurality of providers, and wherein the bot testing application is configured to enable the testing user to select an operating mode selecting the simulated communications client user interface and the simulated communications service backend from amongst those of said plurality of providers.

4. The method of claim 3, where the simulating of the at least one backend function includes sending and/or receiving one or more types of communication, the types of communication sent and/or received being dependent upon the selected operating mode.

5. The method of claim 2, where for each of the human-controlled contacts, a respective further instance of the simulated communications client user interface is rendered in a separate window and a new respective unique user ID is generated to identify the human-controlled contact.

6. The method of claim 1, where the simulated communications client user interface is rendered in a web browser window.

7. The method of claim 2, where the simulated communications client user interface is rendered in a web browser window, and upon opening of a further web browser window a further one of said instances of the communications client user interface is rendered generating a new one of said human-controlled contacts and the respective unique user ID.

8. The method of claim 1, where the communication client user interface is rendered in a way other than in a web browser.

9. The method of claim 7, where the operating mode of the new user is defined when the new user is generated.

10. The method of claim 1, where the user associated with the simulated communications client user interface is also associated with non-conversational state information; said non-conversational state information being user defined.

11. The method of claim 10, where the bot is able to give a response to a query relative to said user's non-conversational state information; said communication comprises supplying the non-conversational state information to said at least one bot, thereby causing the bot to respond to the non-conversational state information.

12. The method of claim 10, where the non-conversational state information is location, said location being user defined.

13. The method of claim 10, where the non-conversational state information is presence, said presence being user defined.

14. The method of claim 10, where the non-conversational state information is time and/or date, said time and/or date being user defined.

15. The method of claim 1, where the communication sent and/or received is any one or more of: instant messages, voice calls, video calls, emoticons, picture messages, and/or video messages.

16. A computer program product comprising code embedded on computer-readable storage and configured so as when run on said user terminal to perform operations of:
automatically detecting one or more bots stored locally on a user terminal of a testing user, being a human tester of the one or more bots;
rendering a simulated communications client user interface simulating at least one user interface function of said communication client application, including at least: presenting one or more of the detected bots as one or more respective ones of a plurality of simulated communication contacts within the simulated communications client user interface, with which the testing user can select to communicate; and
providing a simulated communications service backend simulating at least one backend function of said communication service, including at least: allowing the human tester to communicate with at least one of the one or more presented communication contacts, including at least one of said bots, so as to appear to be a published bot.

17. A user terminal for carrying out a method of testing one or more bots, each bot being for interacting with one or more human users via a communication service implemented over a network where the bot is to be published to a server and the one or more users access the communication service using a communication client application; the user terminal comprising:
storage means for storing the one or more bots;
a detecting module for detecting one or more of the bots stored on said storage means;
a user interface simulating module for rendering a simulated communications client user interface simulating at least one user interface function of said communication client application, including at least: presenting one or more of the detected bots as one or more respective ones of a plurality of simulated communication contacts within the simulated communications client user interface, with which a testing user can select to communicate; and
a backend simulating module for providing a simulated communications service backend simulating at least one backend function of said communication service, including at least: allowing the human tester to communicate with at least one of the one or more presented communication contacts, including at least one of said bots, so as to appear to be a published bot.

18. The user terminal of claim 17, where the user terminal also comprises a network interface, wherein the network interface is configured to connect to a local network to which one or more further user terminals are connected; said further user terminal comprising one or more further, human-controlled contacts each having an instance of said simulated communications client user interface, wherein the further human-controlled contacts are controlled by one or more further human users.

19. The user terminal of claim 17, where the user interface simulating module and the backend simulating module are configured to render and provide respectively in addition to the detected bots, one or more of said plurality of simulated communication contacts comprising one or more further, human-controlled contacts each having an instance of said simulated communications client user interface, wherein the further human-controlled contacts are controlled by said testing user and/or one or more further human users.

20. The user terminal of claim 17, where the user interface simulating module and the backend simulating module are configured to be platform agnostic in that it is operable to simulate a communications client user interface and backend of a plurality of providers, and wherein the bot testing application is configured to enable the testing user to select an operating mode selecting the simulated communications client user interface and the simulated communications service backend from amongst those of said plurality of providers.
